(19) United States
(12) Patent Application Publication
(10) Pub. No.: US 2006/0086718 A1
(43) Pub. Date: Apr. 27, 2006

(54) Soldering method and device

(75) Inventors: Shimpei Fukamachi, Kitamoto-shi (JP); Hirokazu Otani, Hanyu-shi (JP); Takashi Fujino, Higashiiwai-gun (JP); Atsushi Fukamachi, Kitamoto-shi (JP)

Correspondence Address: GREENBLUM & BERNSTEIN, P.L.C., 1950 ROLAND CLARKE PLACE, RESTON, VA, 20191, US

(73) Assignee: TECHNO LAB COMPANY, Saitama 348-0041 (JP)

(21) Appl. No.: 10/532,981

(22) PCT Filed: Oct. 30, 2003
(86) PCT No.: PCT/JP03/13903

§ 371 Date: Apr. 28, 2005

(30) Foreign Application Priority Data
Nov. 1, 2002 (JP) 2003-320097
Feb. 21, 2003 (JP) 2003-44766

(51) Int. Cl. B23K 1/002

(52) U.S. Cl. 219/616

(57) ABSTRACT

A soldering method in which, out of soldering steps of (a) during soldering, (b) before soldering, and (c) after soldering, in at least the steps of (a) during soldering and (b) before soldering, an alternating current whose frequency temporally changes in a band of 20 Hz-1 MHz is applied to at least any of (d) a solder material, (e) a soldering object, and (f) a peripheral portion thereof, and a modulated electromagnetic wave treatment is carried out by use of an electromagnetic field induced by the alternating current. Thereby, when not only a lead-containing solder material but also a lead-free solder material are used, wettability in soldering to a soldering object is made better, and an obtained soldered article is improved in strength, etc., compared to the conventional solder material.

### TECHNICAL FIELD

The present invention relates to a soldering method and device using a lead-free solder or a lead-containing solder, and in particular, a method and device for soldering while treating a solder with modulated electromagnetic waves.

### BACKGROUND ART

With regard to lead-containing solders such as an Sn—Pb eutectic solder, etc., having excellent, various types of performance, since fumes and gases generated during soldering work cause contamination of the soldering workspace environment and an adverse health effect to the operator and it is necessary to make toxic substances nontoxic when printed circuit boards, etc., using lead-containing solders are disposed of, more lead-free soldering devices have tended to be employed in place of these lead-containing solders.

For soldering using a lead-free solder, eutectic solders of Sn—Ag bases (Sn-3-5% Ag-0.5-3% Cu bases), Sn—Cu bases (Sn-0.7% Cu-1.2% Ag bases), etc., are regarded as promising in a flow process, and in a reflow process, Sn—Ag bases, Sn—Zn bases, Sn—Ag—In base, Sn—Bi bases, etc., and in a manual soldering or robot soldering process, Sn—Ag bases, Sn—Cu bases, and Sn—Bi bases (Katuaki Suganuma, “2003-1 Supplemental Issue, Electronic Technology” pp. 2-14, Kogyo Chosakai Publishing Co., Ltd. published Mar. 1, 2003).

### DISCLOSURE OF THE INVENTION

Among the above-mentioned conventional lead-free solder alloys, in particular, the Sn—Ag base (such as 96.5% Sn-3.0% Ag-0.5% Cu) is the most dominant lead-free solder alloy, however, even in this lead-free solder, the following problems have existed compared to the Sn—Pb based solder.

(1) Decline in Wettability

An Sn—Ag—Cu based solder can be considered in which Ag has been added to increase an Sn—Cu based solder in wettability. However, with the increase in the Ag adding ratio to the Sn—Cu based solder, the size of Ag—Sn particles and the size of Ag—Sn/β-Sn eutectic network rings become minute. As a solder structure, a state where minute alloy components are dispersed is desirable, therefore, it is preferable that the Ag amount is largely contained to some extent.

(2) Decline in Solder Strength

Although an Sn—Ag—Cu based solder rises in alloy strength with an increase in the Ag amount in the alloy and shows the highest strength with an eutectic composition of 3.5% Ag, this corresponds to miniaturization of the alloy structure. However, the strength somewhat deteriorates when the composition becomes an excessive eutectic composition of 4% Ag.

(3) In Addition, a (A) Bridge, (B) Fillet, (C) Lift-Off, or (D) Shrinkage Cavity May Occur During Soldering.

An object of the present invention is to provide a soldering method and device which suppresses unfavorable phenomena that occur in soldering using lead-free solders and lead-containing solders, such as an inferior wettability, occurrence of abridge, pinhole or the like, to a minimum.

Moreover, an object of the present invention is to provide a soldering method and device which reduces the silver content as small as possible and also uses a solder which displays performance equivalent to that of a lead-containing solder.

Furthermore, an object of the present invention is to provide a soldered article and a manufacturing method and manufacturing device thereof for manufacturing a circuit board of a semiconductor device or the like, a solder-plated plastic, metal, etc., by use of the above-mentioned soldering method and device.

The objects of the present invention will be achieved by the following constructions.

The present invention is a soldering method in which, out of soldering steps of (a) during soldering, (b) before soldering, and (c) after soldering, in at least the steps of (a) during soldering and (b) before soldering, an alternating current whose frequency temporally changes in a band of 20 Hz-1 MHz is applied to at least any of (d) a solder material, (e) a soldering object, and (f) a peripheral portion thereof, and a modulated electromagnetic wave treatment is carried out by use of an electromagnetic field induced by the alternating current.

According to the present invention, by treating a solder in a molten state itself with modulated electromagnetic waves or treating a soldering ambient atmosphere in a soldering step with modulated electromagnetic waves, wettability in soldering is made better, and an obtained soldered article is improved in strength, etc., compared to the conventional solder material.

In the present invention, although the reason that the soldering performance is improved is unclear, it can be considered that, in the process of cooling the molten solder, since minute eutectic crystals are formed as a result of a modulated electromagnetic wave treatment to a solder composition or a soldering object, effects are provided such that the wettability, which always comes into question in soldering, is improved, and pinholes or bridges become difficult to be formed.

Furthermore, since minute eutectic crystals of the solder are formed as a result of the cooling of the soldering object in an electromagnetic field ambient atmosphere carried out after soldering, quick-cooling, which is carried out in ordinary soldering, becomes unnecessary.

In addition, the modulated electromagnetic wave treatment in the soldering steps of.(a) during soldering, (b) before soldering, and (c) after soldering includes at least any electromagnetic wave treatment of an electromagnetic wave treatment (electromagnetic wave treatment 1) to a flux liquid itself in a flux treatment step, an electromagnetic wave treatment (electromagnetic wave treatment 2) to a flux treatment space, an electromagnetic wave treatment (electromagnetic wave treatment 3) to a preheater space in a preheater treatment which is carried out for a flux-treated soldering object, an electromagnetic wave treatment (electromagnetic wave treatment 4) carried out during soldering, an electromagnetic wave treatment (electromagnetic wave treatment 5) to a soldering space, and an electromagnetic wave treatment (electromagnetic wave treatment 6) to a cooling space in a cooling step for a soldering object after soldering.

Although it is desirable that all of the above-mentioned electromagnetic wave treatments 1-6 are carried out, in order to achieve the objects of the present invention, by securely carrying out an electromagnetic wave treatment in, at least, the flux treatment step of a pre-step of soldering, the preheater treatment step, and the soldering step to the board, an improving effect of the wettability can particularly be enhanced.

In addition, it is also possible to promote permeation (wettability) of the flux by making the flux liquid itself of the pre-soldering step, the molten solder liquid itself of the soldering step, the flux treatment ambient atmosphere and/or the soldering ambient atmosphere into an electromagnetic field ambient atmosphere of the present invention. Thus, adhesion between the soldering object (a conductive terminal of a circuit board or the like) and solder may be improved. In addition, the adhesion between the soldering object and solder may be improved by forming the electromagnetic field ambient atmosphere even without carrying out a flux treatment.

As such, the soldering method of the present invention is not limited to a molten-solder soldering method, but can be applied to a soldering method including a step of, after thermal melting, soldering and cooling of the molten solder.

The above-mentioned soldering can be applied to every type of soldering method such as a soldering method of (a) a flow type whereby a molten solder material is sprayed on a soldering object, (b) a reflow type whereby a soldering object with a solder material applied is heated, or (c) an iron-soldering type (including robot soldering) whereby soldering is carried out by holding a soldering iron to a soldering object with a solder material applied, (d) a laser type or (e) a high-frequency induction heating type.

The above-mentioned (a) flow-type soldering can be applied to both plane dip-type and jet wave dip-type soldering methods of dip soldering (methods for soldering by dipping a soldering object with a flux applied into a molten solder).

Furthermore, the soldering method of the present invention can also be applied to a (c) iron-soldering method, and the above-described iron-soldering method is carried out by manual soldering or automatic soldering by a robot. And, these iron-soldering methods are carried out by means of the following soldering irons.

The soldering irons include, for example, (i) a burning soldering iron, a gas soldering iron, an electric soldering iron, (ii) an ultrasonic soldering iron (which is used for soldering carried out, without using a flux, by breaking an oxide membrane of a base metal by utilizing a cavitation phenomenon generated by ultrasonic vibration, such as, for example, aluminum soldering), (iii) a resistance soldering iron (which is used for soldering carried out by, while sandwiching members to be joined between electrodes made of a metal or carbon, applying hereto a large current at a low voltage and heating with Joule heat generated at the joint portion, such as, for example, soldering between a conductive terminal of a semiconductor circuit board and an electrical wire), and (iv) a chemical soldering iron (which is used for soldering carried out by utilizing heat of a chemical reaction and suitable for an emergency operation in a workspace where generation of fire, sparks and the like causes a danger or in the open air).

In addition, in a case where a lead-free solder material is used as a soldering material used in the present invention, the wettability and solder strength in soldering are made better, however, without limitation to lead-free solder materials, the present invention can also be applied to lead-containing solder materials.

In addition, although the lead-free solder material to which the present invention can be applied is not limited, a solder alloy of an Sn—Ag—Cu base, an Sn—Ag base, an Sn—Ag—Bi base, an Sn—Ag—In base, an Sn—Cu base, an Sn—Zn base, an Sn—Bi base, an Sn—In base, Sn—Sb base, an Sn—Bi—In base, an Sn—Zn—Bi base, or an Sn—Ag—Cu—Sb base can be used.

For example, in a case where a solder alloy of a 96.5% Sn-3.0% Ag-0.5% Cu base or a solder alloy of a 96.0% Sn-3.5% Ag-0.5% Cu base is used as a lead-free solder material, by applying a modulated electromagnetic wave treatment of the present invention, a solder composition can be provided, which is reduced in Ag content (% by weight) to a ratio of 0.5% to above 0% and which uses the reduced amount of Ag as an increasing amount of an Sn content.

In addition, in the present invention, it is possible to make the modulated electromagnetic waves effectively work in a soldering step, in addition to the modulated electromagnetic wave treatment, by carrying out soldering, by use of a stick member provided with a coil portion which conducts an alternating current whose frequency temporally changes in a band of 20 Hz-1 MHz, while orienting the longitudinal direction thereof in the direction of the soldering object. The reason for that is because intensity of the modulated electromagnetic wave becomes strong in the longitudinal direction of the stick member provided with a coil portion.

Furthermore, in the present invention, simultaneously with the modulated electromagnetic wave treatment, by using another electromagnetic wave treatment including an infrared and/or far-infrared treatment in a step before and after soldering, the wettability and solder strength, etc., are improved.

The objects of the present invention will also be achieved by the following constructions.

A soldering device comprising: a solder material applying portion for applying a solder material to a soldering object; a soldering object and/or a solder material for soldering of the soldering object, and/or a coil-wound coil portion provided in the vicinity of the solder material, and an electromagnetic wave generator applies an alternating current whose frequency temporally changes in a band of 20 Hz-1 MHz to an electric wire of the coil portion.

In addition, it is also possible to employ, in addition to the coil portion of the soldering device, a construction provided with a stick member onto which a coil which conducts an alternating current whose frequency temporally changes in a band of 20 Hz-1 MHz has been wound and whose longitudinal direction has been oriented in the direction of the soldering object.

If the soldering device of the present invention is a flow-type device, the solder material applying portion is composed of a molten solder storing molten solder bath attached with a preheating device and/or a flux treatment device and a molten solder supply pipe with an exhaust nozzle to spout the molten solder toward the soldering object, disposed in the molten solder bath, and the coil portion is provided in the vicinity of the molten solder bath and/or in the molten solder supply pipe.

In addition, the modulated electromagnetic wave treatment includes at least any electromagnetic wave treatment of an electromagnetic wave treatment (electromagnetic wave treatment 1) to a flux liquid itself in a flux treatment step, an electromagnetic wave treatment (electromagnetic wave treatment 2) to a flux treatment space, an electromagnetic wave treatment (electromagnetic wave treatment 3) to a preheater space in a preheater treatment which is carried out for a flux-treated soldering object, and an electromagnetic wave treatment (electromagnetic wave treatment 4) carried out during soldering, an electromagnetic wave treatment (electromagnetic wave treatment 5) to a soldering space and/or an electromagnetic wave treatment (electromagnetic wave treatment 6) to a cooling space in a cooling step for a soldering object after soldering.

Although it is desirable that all of the above-mentioned electromagnetic wave treatments 1-6 are carried out, in order to achieve the objects of the present invention, by securely carrying out an electromagnetic wave treatment in, at least, the flux treatment step of a pre-step of soldering, the preheater treatment step, and the soldering step to the board, an improving effect of the wettability can particularly be enhanced.

In addition, the molten solder supply pipe disposed in the molten solder bath is provided with a molten solder intrusion-preventing pipe connected to an outer peripheral portion thereof, and the coil portion is constructed by inserting a coil into the molten solder supply pipe via the inside of the molten solder intrusion-preventing pipe and winding the same.

As such, by constructing the coil portion by inserting a coil into the molten solder supply pipe via the inside of the molten solder intrusion-preventing pipe and winding the same, since the coil is not made to contact with the solder material in a molten state, the coil is hardly deteriorated.

In addition, if the coil portion is constructed by winding, onto a coil installing member connected to the molten solder intrusion-preventing pipe through the inside of the molten solder intrusion-preventing pipe, a coil introduced onto this coil installing member through the inside of the molten solder intrusion-preventing pipe, since fitting of the coil onto the coil installing member can be carried out outside the molten solder bath, maintenance ability is excellent.

If a longitudinal direction of the coil installing member is connected, inside the molten solder intrusion-preventing pipe, to in the direction orthogonal to a longitudinal direction of the molten solder supply pipe, electromagnetic waves can be given from the coil portion of the coil installing member in a direction orthogonal to the flow direction of a molten solder inside the molten solder supply pipe. As a result, an electromagnetic wave energy amount of a higher output is given to the molten solder.

In addition, although the coil can be wound around the coil installing member by single winding or double or more lap winding, the intensity of generated magnetic waves is further increased by double or more lap winding than that of single winding.

In addition, if the coil installing member is provided double with a parallel arrangement in a longitudinal direction of the molten solder supply pipe, and onto these coil installing members, if a coil is wound in a figure of zero or in a figure of eight across the two installing members, generated electromagnetic waves can be given in a wide range, and the electromagnetic wave is also intensified compared to that in a case where the coil portion is provided on a single coil installing member.

If the above-mentioned soldering device of the present invention is a reflow-type device, a solder applying portion thereof is provided with a transfer means for transferring a solder object provided by applying a cream solder to a solder object from an upstream side to a downstream side, a heating means for heating the soldering object being transferred by the transfer means, and a cooling means, and the coil portion is provided with a coil wound around the transfer means for transferring a solder object.

In this case, the coil portion is constructed, for example, by arranging a coil in a direction orthogonal to a transferring direction of a soldering object transferred by the transferring means so as to surround the soldering object.

The heating means is, for example, composed of a preheating portion provided on an upstream side in the transferring direction of the transferring means and a real heating portion provided on a downstream side thereof, and the cooling means is provided on a downstream side of the real heating portion, whereby a modulated electromagnetic wave treatment can be carried out at each stage of soldering of preheating, main heating, and cooling.

If the above-mentioned soldering device of the present invention is a soldering iron-type device, the solder applying portion is provided with a soldering iron for carrying out soldering by being made to contact with or being made proximate to a soldering object with a solder applied, and the coil portion is constructed by winding a coil around a part of the soldering iron.

In this construction, since the coil portion exists at the soldering iron part, modulated electromagnetic waves can be applied toward a soldering object at all times.

In addition, the present invention also includes a method for manufacturing a soldered article wherein the soldering method has been incorporated in manufacturing steps. The soldered article includes all electronic/electrical equipment which requires soldering including semiconductor devices, such as circuit boards provided with semiconductor devices.

In addition, soldered articles such as all electronic/electrical equipment which requires soldering including semiconductor devices, for example, such as circuit boards provided with semiconductor devices, obtained by the soldering method of the present invention are also included in the present invention.

Furthermore, the present invention includes a method and device for manufacturing a soldered article including all electronic/electrical equipment which requires soldering including semiconductor devices, for example, such as circuit boards provided with semiconductor devices, including the soldering device.

### BRIEF DESCRIPTION OF DRAWINGS

FIG. 1 is a perspective view of a soldering device of an embodiment of the present invention.

FIG. 2 is a side schematic view of the soldering device of FIG. 1.

FIG. 3 shows sectional views of the vicinity of a molten solder exhaust-nozzle of a solder supply pipe of the soldering device of FIG. 1 and a semiconductor device being transferred above the molten solder exhaust-nozzle, respectively.

FIG. 4 is a side schematic view of a soldering device of an embodiment of the present invention.

FIG. 5 is a flowchart of a soldering process of an embodiment of the present invention.

FIG. 6 is a side schematic view of a test apparatus to investigate various conditions for a modulated electromagnetic wave treatment of the present invention.

FIG. 7 is a view showing a condition where a modulated electromagnetic wave treatment is being applied in the middle of pouring a molten solder obtained by the test apparatus of FIG. 6 in a mold.

FIG. 8 is a copy of a microphotograph of an ingot polished surface in a case where no modulated electromagnetic wave treatment has been applied by the test apparatus shown in FIG. 6.

FIG. 9 is a copy of a microphotograph of an ingot polished surface in a case where a modulated electromagnetic wave treatment has been applied at 0.3 A and 50-5,000 Hz by only the test apparatus shown in FIG. 6.

FIG. 10 is a copy of a microphotograph of an ingot polished surface in a case where a modulated electromagnetic wave treatment has been applied at 0.3 A and 50-500 kHz by only the test apparatus shown in FIG. 6.

FIG. 11 is a copy of a microphotograph of an ingot polished surface in a case where a modulated electromagnetic wave treatment has been applied at 0.3 A and 50-20,000 Hz by only the test apparatus shown in FIG. 6.

FIG. 12 is a copy of a microphotograph of an ingot polished surface in a case where a modulated electromagnetic wave treatment has been applied at 0.3 A and 50-5,000 Hz in the middle of pouring in the test apparatus shown in FIG. 6 and the mold shown in FIG. 7.

FIG. 13 is a copy of a microphotograph of an ingot polished surface in a case where a modulated electromagnetic wave treatment has been applied at 0.3 A and 50-500 kHz in the middle of pouring in the test apparatus shown in FIG. 6 and the mold shown in FIG. 7.

FIG. 14 is a copy of a microphotograph of an ingot polished surface in a case where a modulated electromagnetic wave treatment has been applied at 0. 3 A and 50-20,000 Hz in the middle of pouring in the test apparatus shown in FIG. 6 and the mold shown in FIG. 7.

FIG. 15 is a copy of a microphotograph of an ingot polished surface of a lead-containing solder to which no modulated electromagnetic wave treatment has been applied.

FIG. 16 is a side sectional view in a case where after semiconductor chip terminals were inserted into through holes provided in a board, conductive wires on the board and the semiconductor chip terminals were optimally soldered via the through holes.

FIG. 17 is a copy of a microphotograph showing a soldering condition around the semiconductor chip terminals in the board through holes in a case where soldering was carried out without applying a modulated electromagnetic wave treatment to a semiconductor device and a molten solder.

FIG. 18 is a copy of a microphotograph showing a soldering condition around the semiconductor chip terminals in the board through holes in a case where soldering was carried out after applying a modulated electromagnetic wave treatment to a semiconductor device and a molten solder at 0. 3 A and 50-5, 000 Hz.

FIG. 19 is a copy of a microphotograph showing a soldering condition around the semiconductor chip terminals in the board through holes in a case where soldering was carried out after applying a modulated electromagnetic wave treatment to a semiconductor device and a molten solder of the part surrounded by a dotted line (b) of FIG. 16 at 0.3 A and 50-500 kHz.

FIG. 20 is a copy of a microphotograph showing a soldering condition around the semiconductor chip terminals in the board through holes in a case where soldering was carried out after applying a modulated electromagnetic wave treatment to a semiconductor device and a molten solder of the part surrounded by a dotted line (a) of FIG. 16 at 0.3 A and 50-500 kHz.

FIG. 21 is a copy of a microphotograph showing a soldering condition around the semiconductor chip terminals in the board through holes in a case where soldering was carried out after applying a modulated electromagnetic wave treatment to a semiconductor device and a molten solder at 0. 3 A and 50-20, 000 Hz.

FIG. 22 is a copy of a microphotograph showing a soldering condition around the semiconductor chip terminals in the board through holes in a case where soldering was carried out by use of a lead-containing solder without applying a modulated electromagnetic wave treatment.

FIG. 23 shows a plan view (FIG. 23(a)) of a test piece of soldering by a modulated electromagnetic wave treatment of the present invention, an enlarged plan view (FIG. 23(b)) and a side view (FIG. 23(c)) of a through hole thereof.

FIG. 24 is a copy of a photograph showing an occurrence of dross on the molten solder surface of a soldering device as a result of a modulated electromagnetic wave treatment of the present invention.

FIG. 25 is a copy of a photograph showing a condition where an occurrence of dross on the molten solder surface of a soldering device as a result of a modulated electromagnetic wave treatment of the present invention has been suppressed.

FIG. 26 is a copy of a photograph showing a condition where an occurrence of dross on the molten solder surface of a soldering device as a result of a modulated electromagnetic wave treatment of the present invention has been suppressed.

FIG. 27 shows a perspective view (FIG. 27(a)) and a side view (FIG. 27(b) showing a connecting portion between a short tube and a molten solder supply pipe of a modulated electromagnetic wave treatment device of the present invention.

FIG. 28 is a perspective view showing a method for winding a coil onto a coil installing member of FIG. 27.

FIG. 29 is a perspective view showing a method for winding a coil onto a coil installing member of FIG. 27.

FIG. 30 is a perspective view showing a method for winding a coil onto parallel-arranged coil installing members of FIG. 27.

FIG. 31 shows a side schematic diagram (FIG. 31(a)) and a plan schematic diagram (FIG. 31(b)) of a reflow soldering device of the present invention.

FIG. 32 is a diagram showing temperatures of a heating zone and cooling zones during reflow soldering of the present invention.

FIG. 33 is a diagram showing a relationship between modulated electromagnetic wave intensity and spacing between two adjacent coils at a coil portion during reflow soldering of the present invention.

FIG. 34 shows explanatory views of a solder spread test during reflow soldering of the present invention.

FIG. 35 is an explanatory view of a solder strength test during reflow soldering of the present invention.

FIG. 36 shows explanatory views when carrying out soldering by iron soldering of the present invention.

FIG. 37 is an explanatory view of a solder spreading during soldering by iron soldering of the present invention.

FIG. 38 is a view for explaining directionality of an electromagnetic wave intensity in a case where an electric wire which conducts a variable frequency has been wound onto a stick body.

FIG. 39 shows diagrams showing a relationship between distance from the coil and electromagnetic wave intensity of the device shown in FIG. 38.

### BEST MODE FOR CARRYING OUT THE INVENTION

Modes for carrying out the present invention will be described along with the drawings.

### Embodiment 1

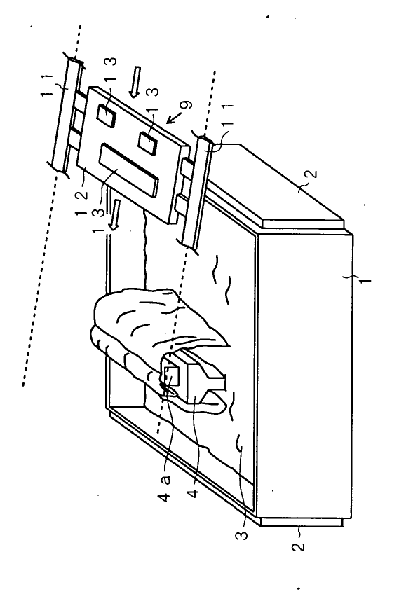

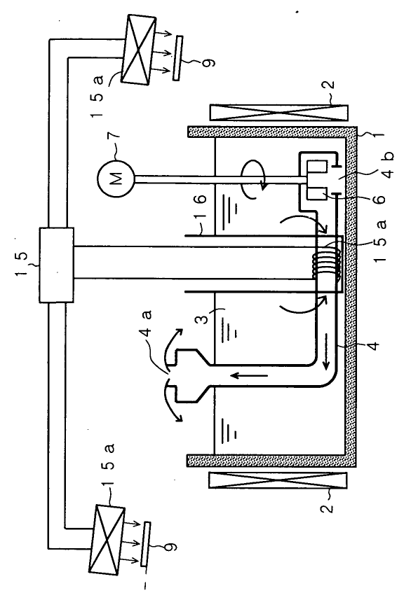

In the present embodiment, a modulated electromagnetic wave treatment of a 96.5% Sn-3.0% Ag-0.5% Cu-based solder was carried out by use of a jet wave dip-type soldering device shown in the perspective view of FIG. 1 and side schematic view of FIG. 2.

The jet wave dip-type soldering device of the present embodiment has a bath 1 of a molten 96.5% Sn-3. 0% Ag-0. 5% Cu-based solder and heaters 2 disposed therearound, and in the bath 1 storing a molten solder 3, a molten solder supply pipe 4 with an exhaust nozzle 4a for exhausting the molten solder 3 by inducing the same above the surface is provided. An induction fan 6 (FIG. 2) is provided at a molten solder intake 4b, and by rotating the fan 6 by a motor 7, the molten solder 3 in the solder bath 1 can be supplied through the solder supply pipe 4 to its exhaust nozzle 4a. In addition, a component to be soldered (in the present embodiment, a semiconductor device 9) is transferred by a transfer unit 11 for a soldering object which passes above the exhaust nozzle 4a.

Respective sectional views in the vicinity of the molten solder exhaust-nozzle 4a of the solder supply pipe 4 and the semiconductor device 9 being transferred above the molten solder exhaust-nozzle 4a are shown in FIG. 3.

At the semiconductor device 9, conductive terminals 13a of a semiconductor chip 13 have been inserted beforehand in through holes 12a provided in a board 12, and during a pass above the molten solder exhaust-nozzle 4a of the solder supply pipe 4, the conductive terminals 13a in the through holes 12a are soldered onto unillustrated electric wiring on the board 12.

Although a coil 15a of a modulated electromagnetic wave generator 15 may be directly wound around the molten solder supply pipe 4, it is more preferable to, as shown in FIG. 2, wind a coil 15a of a modulated electromagnetic wave generator 15 around the outer circumferential portion of the molten solder supply pipe 4 while covering a part of the outer circumferential portion of the molten solder supply pipe 4 immersed in the molten solder bath 1, extending upward beyond the liquid surface of the solder liquid of the molten solder bath 1, and passing through the inside of a short pipe (molten solder intrusion-preventing pipe) 16 structured to prevent the molten solder 3 from intruding inside. In this case, since the coil 15a never directly makes contact with the molten solder 3, deterioration of the coil 15a is minimal.

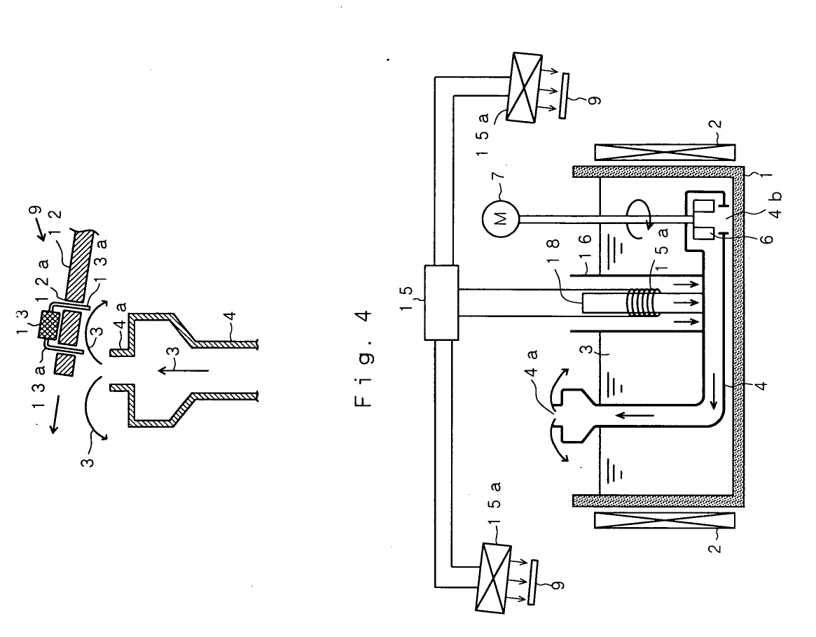

In addition, such a method may be employed, as shown in FIG. 4, winding a coil 15a of a modulated electromagnetic wave generator 15 around a coil installing member 18 while covering a part of the outer circumferential portion of the molten solder supply pipe 4 immersed in the molten solder bath 1, extending upward beyond the liquid surface of the solder liquid of the molten solder bath 1, and connecting the coil inserting member 18 to the inside of a short pipe 16 structured to prevent the molten solder 3 from intruding inside. In this case as well, similar to the case as shown in FIG. 2, since the coil 15a never directly makes contact with the molten solder 3, deterioration of the coiled part is minimal. The coil installing member 18 is made of metal, plastic, or a material such as a ceramic material and others.

The construction shown in FIG. 4 facilitates winding a coil 15a compared to the construction shown in FIG. 2, and has a feature, in a case where the coil wound part is incorporated in a molten solder device, for readiness of post processing. Furthermore, in the example shown in FIG. 4, since the coil installing member 18 is connected in a direction almost orthogonal to the longitudinal direction of the molten solder supply pipe 4, electromagnetic waves can be given by the coil 15a wound around the coil installing member 18, in a direction orthogonal to the flow direction of the molten solder inside the molten solder supply pipe 4. As a result, an electromagnetic wave energy amount of a higher output is given to the molten solder.

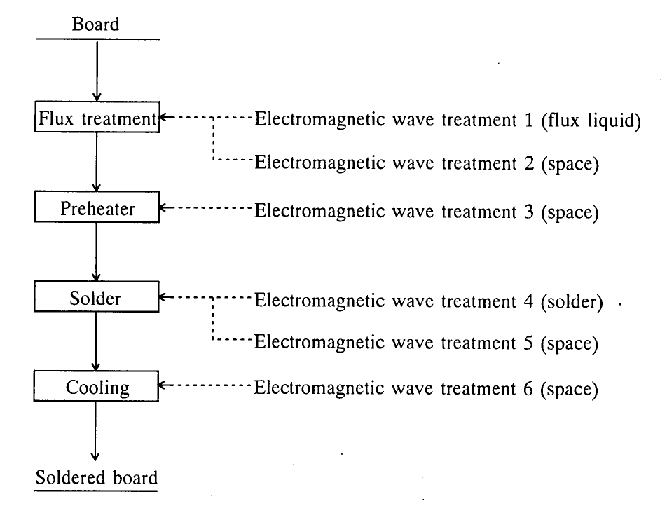

A flow of electromagnetic wave treatments carried out by use of the device shown in FIG. 2 or FIG. 4 is as shown in FIG. 5.

First, a flux treatment is carried out for a board 12 to be soldered, and in this flux treatment step, an electromagnetic wave treatment is applied to the flux liquid itself (electromagnetic wave treatment 1) or an electromagnetic wave treatment is applied to the flux treatment space (electromagnetic wave treatment 2). Next, a preheater treatment is carried out for the flux treated board 12, and at this time as well, an electromagnetic wave treatment is applied to the preheater space (electromagnetic wave treatment 3). In soldering onto the board 12 to be carried out next as well, an electromagnetic wave treatment is carried out (electromagnetic wave treatment 4). At this time as well, an electromagnetic wave treatment is applied to the soldering space (electromagnetic wave treatment 5). After soldering onto the board 12 ends, the soldered board 12 is cooled. In this cooling step as well, an electromagnetic wave treatment is desirably carried out for the cooling space (electromagnetic wave treatment 6).

Although it is desirable that all of the above-mentioned electromagnetic wave treatments 1-6 are carried out, it is necessary, in order to achieve the objects of the present invention, to securely carry out an electromagnetic wave treatment, at least, in the preheater treatment and in the soldering onto the board 12.

Various conditions for the modulated electromagnetic wave treatments of the present embodiment were examined as follows.

The following experiment was carried out, by a modulated electromagnetic wave treatment, to confirm, compared to a lead-containing solder, to what degree of effects wettability and the like a lead-free solder provides.

(1) Modulated Electromagnetic Wave Treatment

In order to examine various conditions for the above-mentioned modulated electromagnetic wave treatment, a modulated electromagnetic wave treatment was carried out by a test apparatus shown in FIG. 6. In FIG. 6, a molten material 3 of the following various types of solder materials was placed in a solder bath 17 on whose side walls heaters 2 had been provided, and a coil 15a for oscillating a variable frequency from a modulated electromagnetic wave generator 15 was wound around the outside of the heaters 2.

(a) Various Types of Solder Materials and Flux Material

(A) Lead-Containing Solder

Solder made from 63 wt % Sn and 37 wt % Pb

(B) Lead-Free Solder

A solder flux material made from 96.5 wt % Sn, 3 wt % Ag, and 0.5 wt % Cu

A mixture of 20˜30% rosin, a 1% or less amine-based activator, and a solvent (alcohol or the like)

(b) Current Value and Frequency of Modulated Electromagnetic Wave Treatment

(A) Coil current value 0.1-5 A (variable)

(B) Frequency 50-500 kHz

(c) Soldering

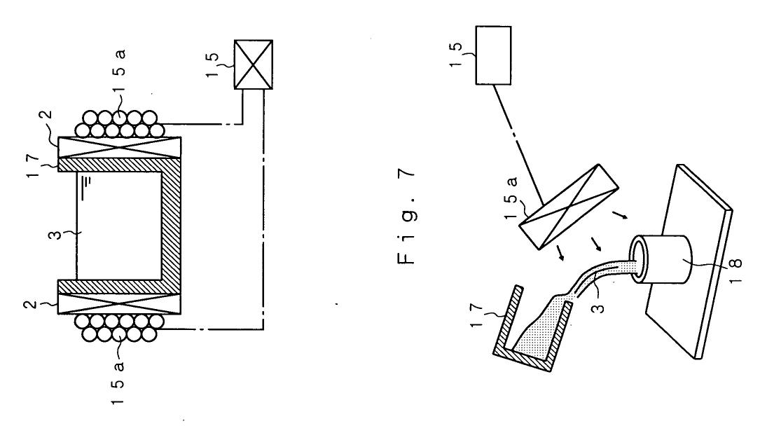

After applying a modulated electromagnetic wave treatment to a molten solder 3 inside the solder bath 17 in FIG. 6 from the surroundings of the bath 17 within the range of the above-described (b) coil current value and frequency, the molten solder 3 in the solder bath 17 was poured in a mold 18 as shown in FIG. 7 to form an ingot. At this time, also in the middle of pouring the molten solder 3 in the mold 18 as shown in FIG. 7, in some cases, a modulated electromagnetic wave treatment was carried out at the coil current value and frequency of the above-described (b), and in some cases, the modulated electromagnetic wave treatment was not carried out.

(d) Observation of a Cut Surface

Next, after cooling the ingot, the cut surface was polished after cutting, the polished surface was checked with a microscope, and metal grain boundaries and crystal conditions were confirmed. Here, the ingot was cooled and solidified from its surface toward its center portion in order, and photomicrographs shown in the following are all photos of a part near the ingot surface shown with a magnification of 100 times.

(2) Test Result 1

This test result 1 is a test result in a case where, after a modulated electromagnetic wave treatment was carried out by the test apparatus shown in FIG. 6 for the above-described molten solder materials (A) and (B), the modulated electromagnetic wave treatment was not carried out in the middle of pouring the same in the mold 18 shown in FIG. 7. At this time, the coil current value was fixed at 0.3 A, and modulated magnetic waves included (a) no treatment, (b) 50-5,000 Hz, (c) 50-500 kHz, and (d) 50-20,000 Hz.

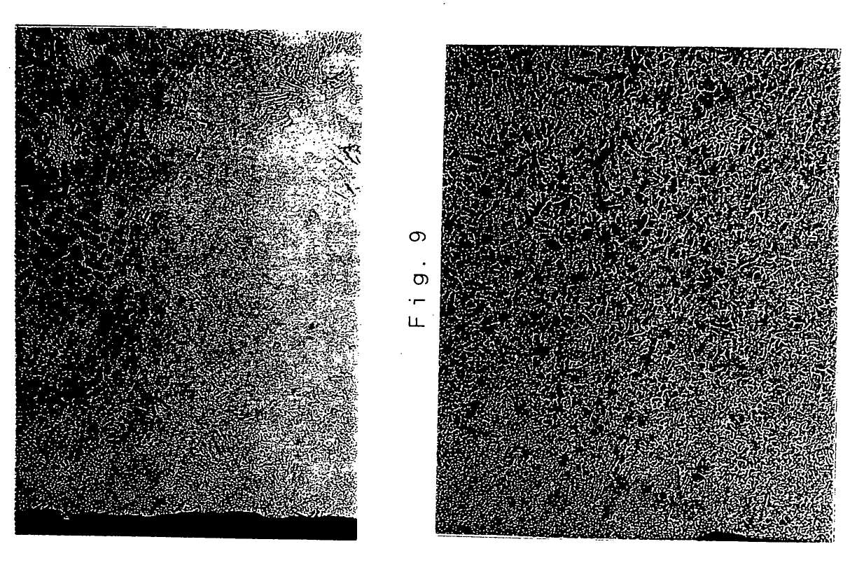

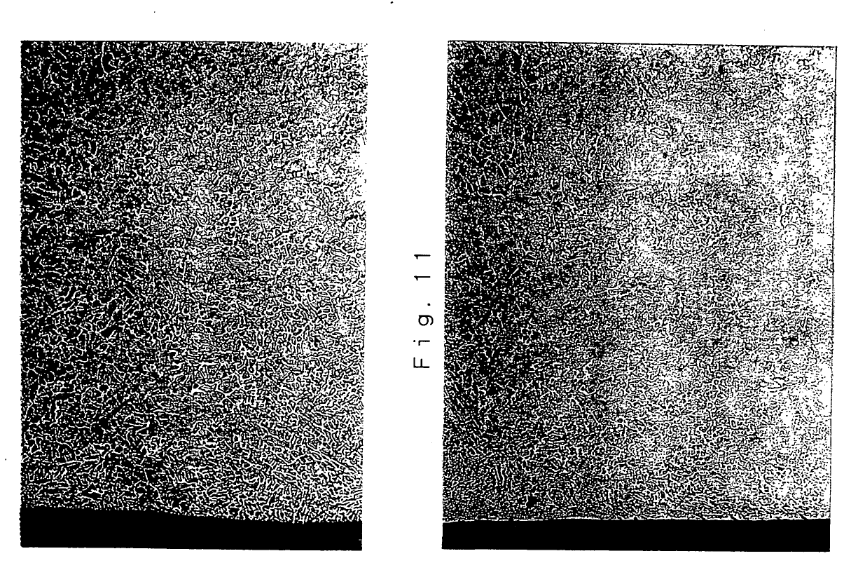

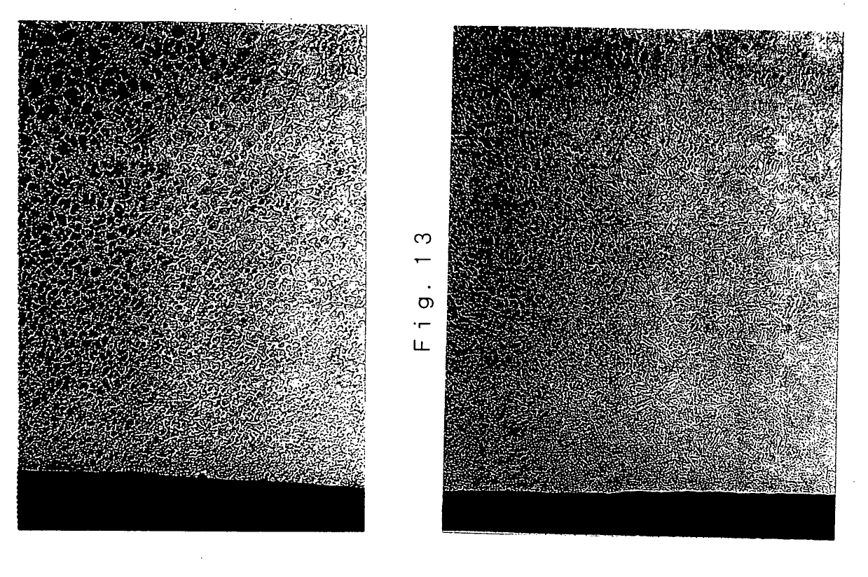

Results of the above-mentioned (a)-(d) are shown in FIG. 8, FIG. 9, FIG. 10, and FIG. 11, respectively.

(3) Test Result 2

This test result 2 is a test result in a case where, after a modulated electromagnetic wave treatment was carried out by the test apparatus shown in FIG. 6 for the above-described molten solder materials (A) and (B), the modulated electromagnetic wave treatment was performed in the middle of pouring the same in the mold 18 shown in FIG. 7.

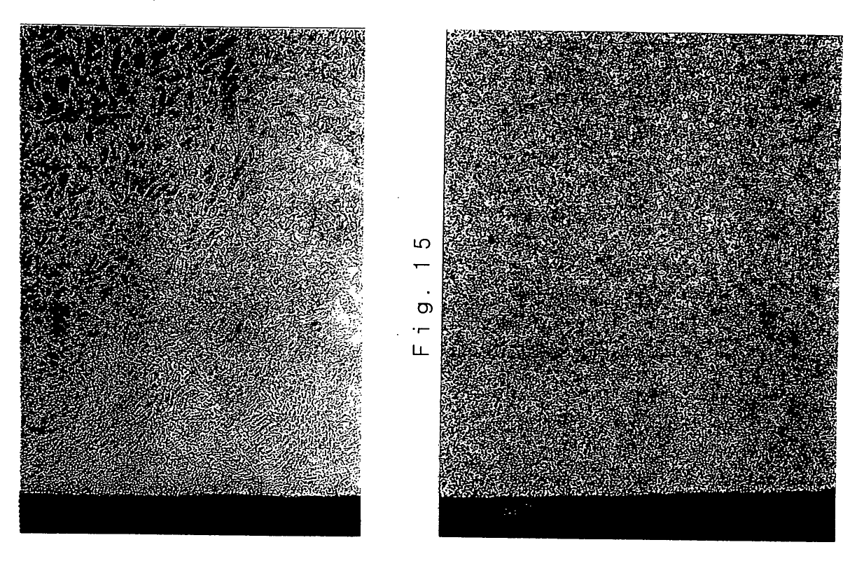

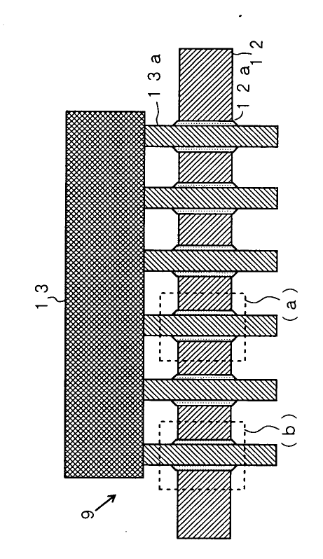

At this time, the coil current value was fixed at 0.3 A, and modulated electromagnetic waves included (a) 50-5,000 Hz, (b) 50-500 kHz, and (c) 50-20,000 Hz for the treatment. Results of the above-mentioned (a)-(c) are shown in FIG. 12, FIG. 13, and FIG. 14, respectively.

In addition, a photomicrograph of a polished ingot surface in a case where the modulated electromagnetic wave treatments shown in FIG. 6 and FIG. 7 were never carried out is as shown in FIG. 8 as mentioned above.

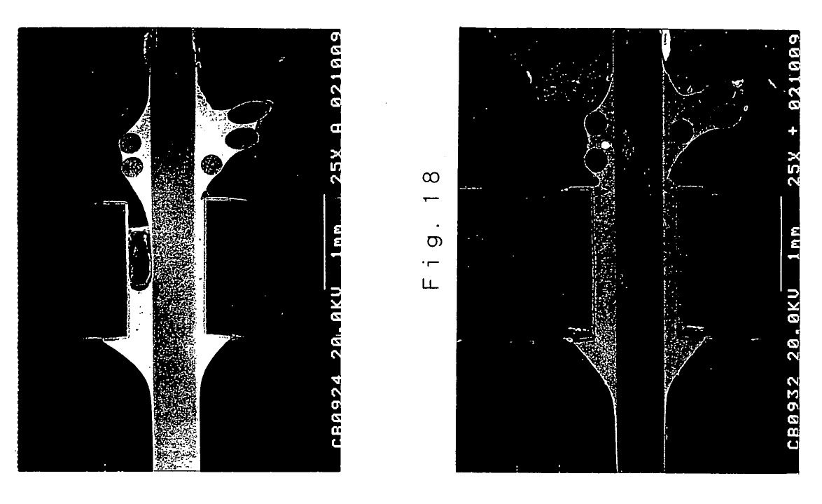

Furthermore, a photomicrograph of a polished ingot surface in a case where the above-mentioned molten lead-containing solder material (A) was used and the modulated electromagnetic wave treatments shown in FIG. 6 and FIG. 7 were never carried out is as shown in FIG. 15.

As such, FIG. 8-FIG. 14 are results of cases where the lead-free solder (B) of the (1)(b) was used, and FIG. 15 is a result of a case where the lead-containing solder (A) of the (1)(a) was used.

(4) Consideration of Test Results 1 and 2

Based on the above test results 1 and 2, it can be understood that, compared to the photomicrograph (FIG. 8) of the polished ingot surface in a case where the modulated electromagnetic wave treatments shown in FIG. 6 and FIG. 7 were never carried out for the above-mentioned molten lead-free solder material (B), relatively uniform eutectics were obtained in the photomicrographs (FIG. 9-FIG. 11) of the polished ingot surfaces in cases where the modulated electromagnetic wave treatment shown in FIG. 6 was carried out for the above-mentioned molten lead-free solder material (B).

In addition, it can be understood that, in the photomicrographs (FIG. 12-FIG. 14) of the polished ingot surfaces in cases where the modulated electromagnetic wave treatments shown in FIG. 6 and FIG. 7 were both carried out for the above-mentioned molten lead-free solder material (B), further uniform eutectics were obtained compared to the photomicrographs (FIG. 9-FIG. 11) of the polished ingot surfaces in cases where only the modulated electromagnetic wave treatment shown in FIG. 6 was carried out.

Since, in the photomicrographs of FIG. 12-FIG. 14, uniform eutectics equivalent to or above those of the photomicrograph (FIG. 15) of a polished ingot surface obtained from the above-mentioned lead-containing solder material (A), which has been conventionally widely used, were obtained, it became clear that, by carrying out the modulated electromagnetic wave treatments of the present embodiment, even a lead-free solder material can be a replacement for a lead-containing solder material having an established reputation for its performance.

In addition, it was discovered that not only applying a modulated electromagnetic wave treatment to the molten solder in the solder bath shown in FIG. 6 but also carrying out a modulated electromagnetic wave treatment in the middle of pouring the molten solder in the mold is effective.

(5) Result of Application to an Actual Device

By use of a jet wave dip-type melt soldering device 1 shown in FIG. 1, conductive wires on the board 12 of the semiconductor device 9 and conductive terminals 13a of the semiconductor chip 13 were soldered.

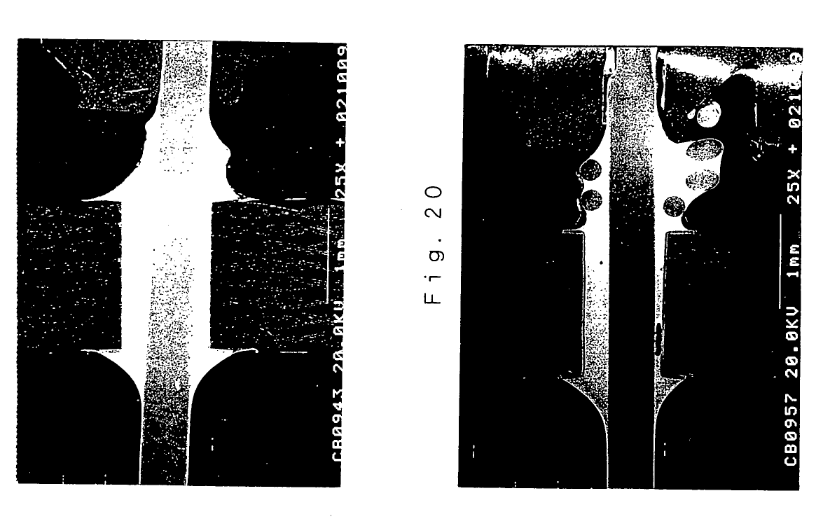

FIG. 16 is a side sectional view in a case where after terminals 13a of a semiconductor chip 13 were inserted into through holes 12a provided in a board 12, conductive wires on the board 12 and the terminals 13a of the semiconductor chip 13 were optimally soldered via the through holes 12a.

Similar to the conditions of the above-mentioned test result 2, the coil current value is fixed at 0.3 A, and with regard to the modulation frequency whose frequency temporally changes, on

(a) No treatment,

(b) 50-5,000 Hz,

(c) 50-500 kHz, and

(d) 50-20,000 Hz,

a modulated electromagnetic wave treatment was applied to the semiconductor device 9 before soldering, a modulated electromagnetic wave treatment was applied to the molten solder 3 in the molten solder supply pipe 4, and furthermore, a modulated electromagnetic wave treatment is applied to the semiconductor device 9 as well.

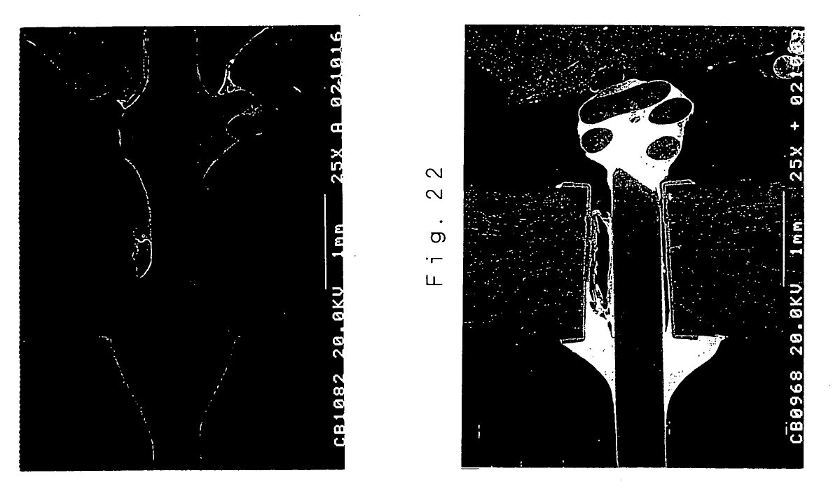

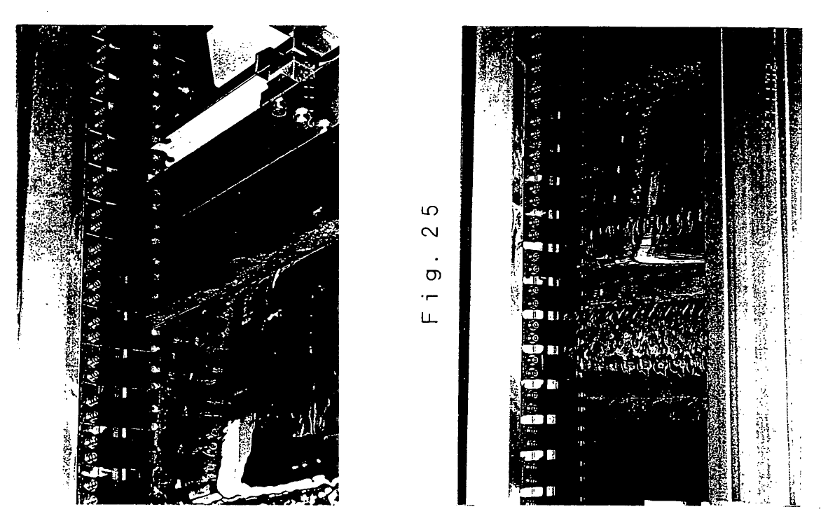

Sections showing soldered conditions around the semiconductor chip terminals 13a in the board through holes 12a in cases where no modulated electromagnetic wave treatment was applied with the above-mentioned conditions (a)-(d) and in cases where soldering of the semiconductor device 9 was carried out while applying a modulated electromagnetic wave treatment are shown in FIG. 17-FIG. 22 as photomicrographs with a magnification of 25 times. The photomicrographs of FIG. 17, FIG. 18, FIG. 20, and FIG. 21 show cases where, in the part surrounded by a dotted line (a) of FIG. 16, soldering was carried out in respective conditions after a soldering treatment was treated with the above-mentioned conditions (a)-(d), respectively, in order.

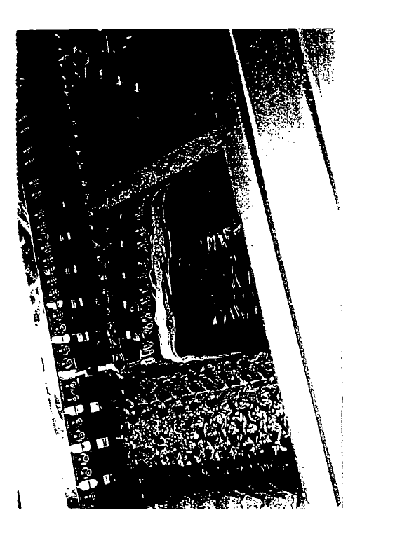

Here, FIG. 17-FIG. 21 are results of cases where the lead-free solder material (B) of the (1) (b) was used, and FIG. 22 is a result of a case where the lead-containing solder material (A) of the (1)(a) was used.

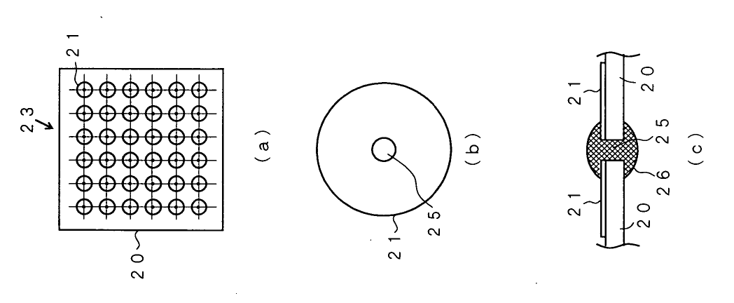

In addition, the photomicrograph of FIG. 19 shows a case where, in the part surrounded by a dotted line (b) of FIG. 16, soldering was carried out in respective conditions after a soldering treatment was treated with the above-described condition(c). In addition, FIG. 22 shows a case where soldering was carried out by use of the lead-containing solder material (A) without applying a modulated electromagnetic wave treatment.

In FIG. 17, a result of soldering on the above-mentioned condition (a) without a modulated electromagnetic wave treatment is shown, and it can be understood that the solder has not sufficiently intruded in the gap between the through hole 12a of the board 12 and terminal 13a of the semiconductor chip 13.

In FIG. 18, a result of soldering carried out while applying a modulated electromagnetic wave treatment with the above-mentioned condition (b) is shown, wherein the solder has sufficiently intruded in the gap between the through hole 12a of the board 12 and terminal 13a of the semiconductor chip 13, indicating that soldering has been satisfactorily carried out even in the narrow space.

In FIG. 19, a result of soldering of apart of the terminals 13a of the semiconductor chip 13 carried out at a position ((b) in FIG. 16) with relatively few obstacles in an end portion of the semiconductor device 9 while applying a modulated electromagnetic wave treatment for the above-mentioned condition (c) is shown, wherein the solder has sufficiently intruded in the gap between the through hole 12a of the board 12 and terminal 13a of the semiconductor chip 13, indicating that soldering has been carried out in the most satisfactory condition in the present embodiment.

In FIG. 20, a result of soldering of a part of the terminal 13a of the semiconductor chip 13 carried out at a position with relatively many obstacles in a central portion of the semiconductor device 9 with the above-mentioned condition (c) is shown, wherein the solder has sufficiently intruded in the gap between the through hole 12a of the board 12 and terminal 13a of the semiconductor chip 13 to an extent approximately the same as in FIG. 19, indicating that soldering has been carried out in a satisfactory condition.

In FIG. 21, a result of soldering carried out while applying a modulated electromagnetic wave treatment with the above-mentioned condition (d) is shown, wherein the solder has not sufficiently intruded in the gap between the through hole 12a of the board 12 and terminal 13a of the semiconductor chip 13.

In FIG. 22, a result of soldering carried out by use of the lead-containing solder material (A) without applying a modulated electromagnetic wave treatment with the above-mentioned condition (d) is shown, wherein the solder has not sufficiently intruded in the gap between the through hole 12a of the board 12 and terminal 13a of the semiconductor chip 13.

In addition, although this is unillustrated, a so-called “solder run” occurs if the electromagnetic wave intensity is too strong.

Accordingly, it became clear that, by appropriately selecting the conditions for a modulated electromagnetic wave treatment of the present embodiment, soldering excellent in wettability can be carried out by use of the lead-free solder material (B). Moreover, it was discovered that, according to the method of the present embodiment, satisfactory soldering is possible even in comparison with a case where the lead-containing solder material (A) was used.

### Embodiment 2

The present embodiment is, similar to Embodiment 1, a flow-type soldering method, and this is an embodiment wherein soldering while carrying out a modulated electromagnetic wave treatment is carried out by use of a lead-free solder material.

(1) Modulated Electromagnetic Wave Treatment

In order to examine the various conditions for the above-mentioned modulated electromagnetic wave treatment, the modulated electromagnetic wave treatment was carried out by the test apparatus shown in FIG. 6.

(a) Various Types of Solder Materials and Flux Material

(A) Solder made from 96.5 wt % Sn, 3.0 wt % Ag, and 0.5 wt % Cu

(B) Solder made from 97.0 wt % Sn, 2.5 wt % Ag, and 0.5 wt % Cu

(C) Solder made from 97.5 wt % Sn, 2.0 wt % Ag, and 0.5 wt % Cu

(D) Solder made from 98.0 wt % Sn, 1.5 wt % Ag, and 0.5 wt % Cu

Flux Material

A mixture of 20-30% rosin, a 1% or less amine-based activator, and a solvent (alcohol or the like)

(b) Current Value and Frequency of Modulated Electromagnetic Wave Treatment

(A) Coil current value 0.1-5 A (variable)

(B) Modulated Frequency 20 Hz-1 MHz

(c) Soldering

A 30×30mm-sized test piece 23 by providing vertically 6× horizontally 6, a total of 36 circular copper foils 21 with a diameter of 3 mm on a plastic sheet 20 as shown in the plan view of FIG. 23(a) was prepared, and at each center portion of the copper foil 21, a 0.8 mm-through hole 25 (enlarged plan view of FIG. 23(b), side view of FIG. 23(c)) was provided.

After applying a modulated electromagnetic wave treatment from the surroundings of the solder bath 17 in FIG. 6 to the molten solder 3 in the bath 17 within the range of the foregoing (b) coil current value and frequency, the above-mentioned test piece 23 was soldered with the molten solder 3, and a state of wetting and rising of a solder 26 (through hole ability) onto the upper surface of the test piece 23 through the through hole 25 was observed, whereby wettability of the Sn—Ag—Cu-based molten solder was confirmed.

(2) Test Result 1

Similar to actual soldering steps, a comparison was carried out between the cases where a modulated electromagnetic wave treatment of the solder liquid and flux liquid and a modulated electromagnetic wave treatment in a flux treatment step, a preheater step, and a solder treatment step were carried out and cases where no modulated electromagnetic wave treatment was carried out.

In addition, for an influence of an Ag content ratio of the Sn—Ag—Cu-based solder, the through hole effect of the solder 26 via the through hole 25 of the test piece 23 was observed as shown in FIG. 23(b) and FIG. 23(c). The number of through holes which have been wetted and have risen was calculated among the 36 through holes 25.

Results are shown in Table 1.

TABLE 1

| | | Modulated |
|---|---|---|
| | | electromagnetic |
| Sn:Ag:Cu | No treatment | wave treatment |
| 96.5:3.0:0.5 | 28/36 | 32/36 |
| 97.0:2.5:0.5 | 25/36 | 30/36 |
| 97.5:2.0:0.5 | 11/36 | 29/36 |
| 98.0:1.5:0.5 | 8/36 | 20/36 |

As can be seen from Table 1,

(A) It was confirmed that an effect was provided in an improvement in through hole wetting and rising by a modulated electromagnetic wave treatment.

(B) It was discovered that even with a 97.5% Sn-2.0% Ag-0.5% Cu alloy, a through hole effect was obtained to an extent the same as a 3. 0% Ag-containing alloy when a modulated electromagnetic wave treatment was not applied.

(3) Test Result 2 (Mounting Test)

By use of the same test piece 23 as in the above-mentioned test 1, soldering of a 96.5% Sn-3.0% Ag-0.5% Cu alloy by use of the soldering device shown in FIG. 4 was carried out by the above-mentioned (1)(b) electromagnetic waves. At this time, a comparison was carried out between the cases where a modulated electromagnetic wave treatment of the solder liquid and flux liquid and a modulated electromagnetic wave treatment in a flux treatment step, a preheater step, and a solder treatment step was carried out and cases where no modulated electromagnetic wave treatment was carried out.

In order to recognize the difference in the effect of improvement in the through hole wetting and rising between the modulated electromagnetic wave treatment and no treatment, the sizes of the solder diameter and flux diameter were measured by slide calipers. Results are shown in Table 2.

TABLE 2

| | | Solder diameter | | Flux diameter | |
|---|---|---|---|---|---|
| | | (mm) | | (mm) | |
| | Test No. | Mean | CV (%) | Mean | CV (%) |
| No treatment | No. 1 | 0.64 | 4.5 | 1.20 | 19.5 |
| | No. 2 | 0.58 | 8.1 | 1.33 | 6.8 |
| Modulated | No. 3 | 0.88 | 5.4 | 3.00 | 3.3 |
| electromagnetic | No. 4 | 0.90 | 2.0 | 3.07 | 10.6 |
| wave treatment | | | | | |

The following is recognized from the results of Table 2.

(A) The Solder Diameter and Flux Diameter were Both Increased in Expansion by the Electromagnetic Wave Treatment.

This is considered to be a result of an improvement in the through hole wettability, and the influence of a synergetic effect on an improvement in the flux adhesion and wettability is also considered to be great.

(B) From CV(%)=standard deviation/mean×100, as well, it can be understood that an unevenness depending on the electromagnetic process is small, an stable improvement in the through hole wettability is recognized. A through hole effect as a result of the wettability improvement was also recognized in an improvement in the soldering stability.

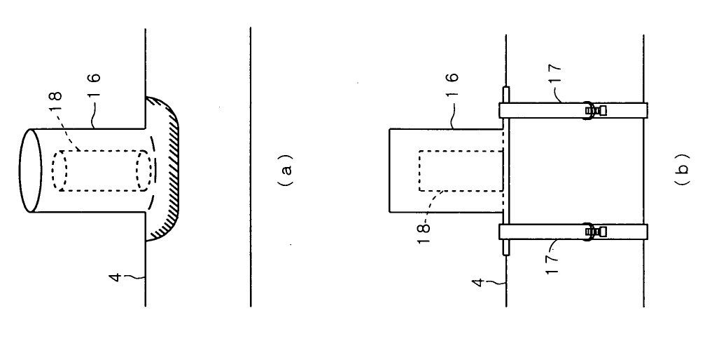

In addition, in a process where soldering is being carried out by circulating a soldering liquid of 96.0 wt % Sn, 3.5 wt % Ag, and 0.5 wt % Cu by use of the soldering device shown in FIG. 4, dross (an impurity (oxidize), etc., floating on the molten solder) is produced on the surface of the molten solder 3 in the soldering device as shown in FIG. 24. This dross can cause an obstruction such as a bridge during soldering.

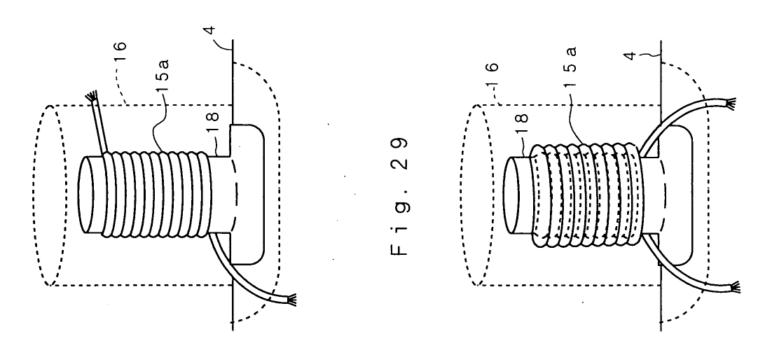

However, when a modulated electromagnetic wave treatment of the present invention was carried out for the solder liquid in the soldering device shown in FIG. 4, the dross disappeared as shown in FIG. 25 (current value 0.3 A ) and FIG. 26 (current value 0.6 A ). Particularly, in the case of a higher current value as shown in FIG. 26, the dross completely disappeared.

In order to apply an electromagnetic wave treatment to a to-be-treated fluid which flows inside a fluid flow path including the molten solder supply pipe 4 shown in FIG. 1, a conductive electric wire (coil) is wound around the fluid flow path or the like, and coil winding method therefor includes the following methods:

A. A method of winding a coil around a fluid path

B. A method of separately connecting a short pipe to a fluid path and winding, in the short pipe, a coil directly onto the fluid path (supply pipe 4 of FIG. 2)

C. A method of winding a coil onto a coil installing member (coil installing member 18 of FIG. 4) connected to a fluid flow path provided in a short pipe

For a soldering device to carry out an electromagnetic wave treatment by the above-mentioned method A, B, or C, in the modulated electromagnetic wave treatments 1-6 shown in the flow of FIG. 5, the method B or C is effective. This is because these methods are simple as treatment methods, and for an incorporation into a soldering device, a subsequent fitting is possible.

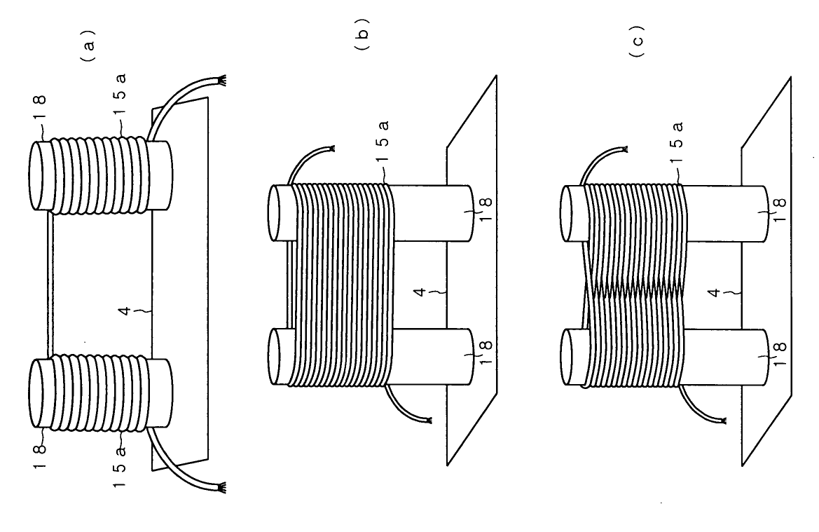

In addition, for the short pipe in the above-mentioned method C, as shown in FIG. 27, a method of connecting, to the fluid flow path, a pad portion provided on a connecting portion to a fluid flow path (molten solder supply pipe 4) of the short pipe 16 by spot welding (FIG. 27(a)) or a method of tightening and fixing a pad portion of the short pipe 16 to the fluid flow path (supply pipe 4) by a band 17 (FIG. 27(b)) exist.

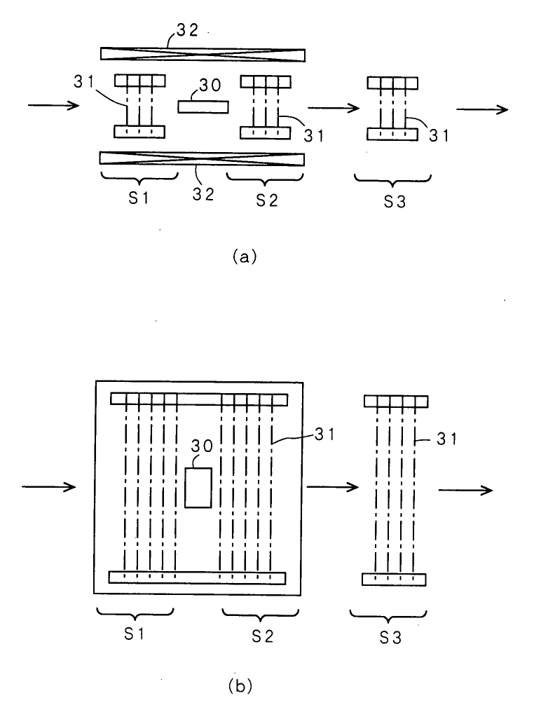

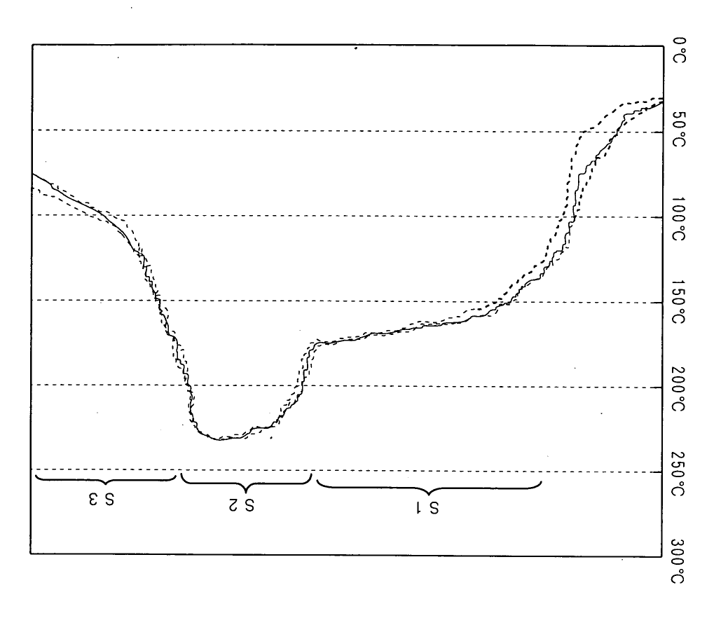

As methods for winding the electric wire (coil) 15a onto the coil installing member 18 or the like, a single winding method wherein a coil 15a is simply wound onto a coil installing member 18 in order as in FIG. 28 and a lap winding method wherein, after a coil is wound inside, further thereon a coil is wound as in FIG. 29 can be mentioned. As such, by providing a coil portion having a coil 15a wound by single winding or a double or more lap winding on the coil installing member 18, an effect is provided in that the intensity of generated electromagnetic waves is increased.

In addition, in a case where the coil installing member 18 is connected double to the fluid flow path in an adjacent manner, as in FIG. 30(a), a winding method wherein, after single winding onto one coil installing member 18, the coil 15a is successively wound onto the other coil installing member 18 is generally employed. As coil 15a winding methods in the case where two coil installing members 18 are adjacently connected to the fluid flow path as in FIG. 30(a), as shown in FIG. 30(b) and FIG. 30(c), winding in a figure of zero and winding in a figure of eight can be mentioned. In this case, the generated electromagnetic waves can be given in a wide range, and an effect to increase the intensity exists.

### Embodiment 3

In the present embodiment, a reflow soldering method will be described.

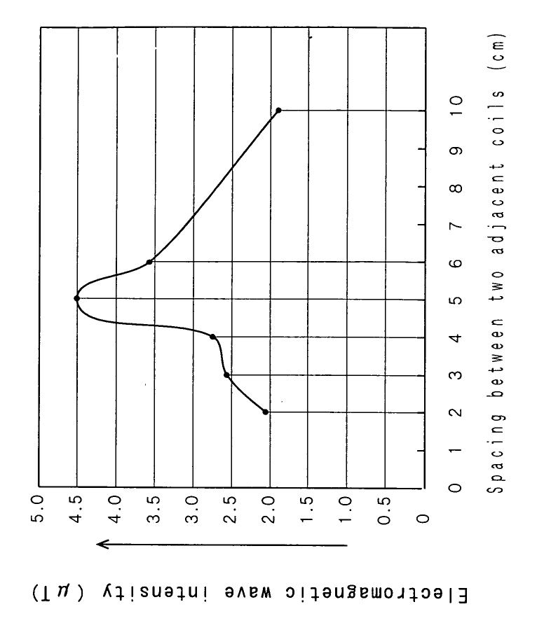

In FIG. 31, a side schematic diagram (FIG. 31(a)) and a plan schematic diagram (FIG. 31(b)) of a reflow soldering device are shown.

In a soldering device case (unillustrated) provided with an entrance and an exit through which a soldering object 30 with a cream solder applied and its transfer unit (unillustrated) pass, a coil portion 31 around which a conductive wire (coil) to generate modulated electromagnetic waves of the present invention has been wound exists at a position surrounding a transfer passage of the soldering object 30 and its transfer unit. The soldering object 30 and its transfer unit are transferred in a space surrounded by the coil portion 31, and in the case, the coil portion 31 is heated from its outside by heaters 32. Moreover, in the case, air is circulating and outside air hardly intrudes.

Heating of the soldering object 30 is carried out at two stages, and a preheater zone S1 and a solder melting zone S2 are heated, wherein the heating temperature is unified and the flux is activated in the preheater zone S1, and soldering is carried out in the solder melting zone S2. Subsequently, the soldered soldering object is cooled in a cooling zone S3.

In all of the above-mentioned three zones S1-S3, the soldering object 30 shifts in a region surrounded by the coil portion 31 to generate electromagnetic waves, and the soldering object 30 and solder material receive an electromagnetic wave treatment from the coil portion 31.

In addition, while confirming by an electromagnetic wave monitoring apparatus (unillustrated) that the effective electromagnetic wave intensity reaches a range on the order of approximately 500 mm from the coil end portion, a coil winding position of the coil portion 31 is disposed at a position close to a soldering part of the soldering object 30 as much as possible. In addition, it is necessary to adjust the coil spacing so that the coil portion 31 for electromagnetic wave generation does not prevent heat to the soldering object 30 from the heaters 32 provided at upper and lower positions of the coil portion 31.

As a relationship between the electromagnetic wave intensity and coil spacing between two adjacent coils in the coil portion is shown in FIG. 33, it was confirmed that securing a spacing between the two adjacent coils at 30-70 mm, no influence was given to the temperature profile.

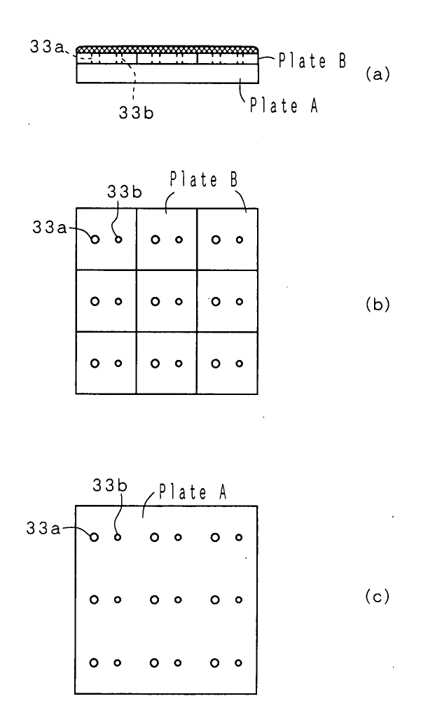

In addition, by attaching a temperature sensor to the respective sections of the solder object and actually carrying out a reflow treatment as set, heating could be carried out at a temperature condition (solid line) almost similar to a temperature condition (dotted line) set as shown in FIG. 32.

(1) Modulated Electromagnetic Wave Treatment

The intensity of electromagnetic waves generated from the coil portion 31 is almost proportional to the coil current value. Since the following harmful effect may occur for an effect of an improvement in the solder wettability by an electromagnetic wave treatment, it is necessary to make the electromagnetic wave intensity appropriate.

Based on the data shown in FIG. 33, if the electromagnetic wave intensity was too high, the spreading of the solder onto the board increases, and the solder overflows from a copper part, which is a conductive portion of the board, and spreads to the plastic sheet. In such a case, the electromagnetic wave output is lowered to an appropriate value.

(2) Solder Material and Flux Material

As a cream solder, Sn:Ag:Cu =96.5:3.0:0.5 (wt %) is used, which is PF305-207SHO (trade name) containing a paste manufactured by NIHON HANDA CO.,LTD.

(3) Current Value and Frequency of Modulated Electromagnetic Wave Treatment

(A) Coil current value: Although the current value is variable between 0.1-5 A, in the present embodiment, the value was fixed to an optimal value of 2 A for a problem (excessive spreading) in a case where the electromagnetic waves were too strong.

(B) Modulation frequency: 20 Hz-1 MHz

(4) Test Result

By use of the following three copper test pieces (A-C), a solder spread test (test 1) and a strength test (test 2) were carried out with the following solder temperatures and electromagnetic waves.

Plate A: 150 mm×150 mm×thickness 1 mm

Plate B: 50 mm×50 mm×thickness 0.3 mm

Plate C: 10 mm×10 mm×thickness 1 mm

Solder temperature: 235° C., 240° C.

(a) Test 1 (Spread Test)

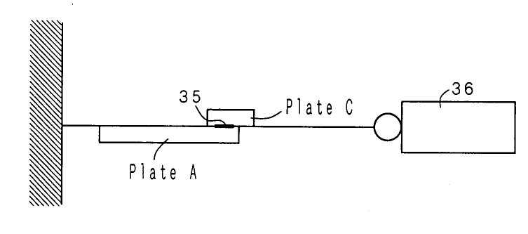

(A) As shown in a side view of FIG. 34(a) and a plan view of FIG. 34(b), holes of φ4 mm and φ3 mm were respectively opened in the plate B, and this plate B was placed on the plate A. A total of nine plates B were placed on the plate A.

(B) After applying a cream solder to the plates B from their upside, by removing the plates B as shown in FIG. 34(c), the solder which had intruded in the holes resulted in a condition where a large number of spots 33a and 33b were left on the plate A.

(C) A reflow treatment was carried out by the device shown in FIG. 31, solder spreading conditions on the plate A was compared between the modulated electromagnetic wave treatment and no treatment by use of slide calipers.

Data about diameters of spots placed on the plate A through the φ4 mm- and φ3 mm-holes of the plates B at 235° C. is shown in Table 3 and Table 4. In addition, data about diameters of spots placed on the plate A through the φ4 mm- and φ3 mm-holes of the plates B at 240° C. is shown in Table 5 and Table 6.

TABLE 3
φ4 mm 235° C.

| | | | Modulated | |
|---|---|---|---|---|
| | | | electromagnetic | |
| Test piece | No treatment | | wave treatment | |
| 1 | 4.25 | mm | 5.10 | mm |
| 2 | 4.90 | | 4.90 | |
| 3 | 4.90 | | 4.95 | |
| 4 | 4.15 | | 5.10 | |
| 5 | 4.90 | | 4.98 | |
| Mean | 4.62 | | 5.01 | |

TABLE 4
φ3 mm 235° C.

| | | | Modulated | |
|---|---|---|---|---|
| | | | electromagnetic | |
| Test piece | No treatment | | wave treatment | |
| 1 | 3.20 | mm | 3.45 | mm |
| 2 | 3.40 | | 3.34 | |
| 3 | 3.40 | | 3.40 | |
| 4 | 3.15 | | 3.42 | |
| 5 | 3.35 | | 3.40 | |
| Mean | 3.28 | | 3.40 | |

TABLE 5
φ4 mm 240° C.

| | | | Modulated | |
|---|---|---|---|---|
| | | | electromagnetic | |
| Test piece | No treatment | | wave treatment | |
| 1 | 5.00 | mm | 5.40 | mm |
| 2 | 5.05 | | 5.40 | |
| 3 | 4.90 | | 5.42 | |
| 4 | 5.02 | | 5.41 | |
| 5 | 4.95 | | 5.43 | |
| Mean | 4.98 | | 5.41 | |

TABLE 6
φ3 mm 240° C.

| | | | Modulated | |
|---|---|---|---|---|
| | | | electromagnetic | |
| Test piece | No treatment | | wave treatment | |
| 1 | 3.81 | mm | 4.12 | mm |
| 2 | 3.80 | | 4.12 | |
| 3 | 3.79 | | 4.10 | |
| 4 | 3.80 | | 4.12 | |
| 5 | 3.78 | | 4.10 | |
| Mean | 3.80 | | 4.11 | |

As shown in the above-mentioned Table 3-Table 6, by carrying out a modulated electromagnetic wave treatment at the above-described conditions, an improvement in “solder spreadability” was recognized compared to cases with no electromagnetic wave treatment.

(b) Test 2 (Solder Strength Test)

(A) A hole of φ1 mm was opened in the plate B, and this plate B was placed on the plate A.

(B) After applying a cream solder to the plate B from its upside, the plate B was removed, then the solder was left on the plate A.

(C) A reflow treatment was carried out by the device shown in FIG. 31 at a temperature of 240° C. for the plate A, and at this time, a reflow treatment where a modulated magnetic wave treatment was not carried out (no treatment) and a reflow treatment where a modulated electromagnetic wave treatment was carried out was carried out.

(D) The plate C was overlapped in a solder molten condition.

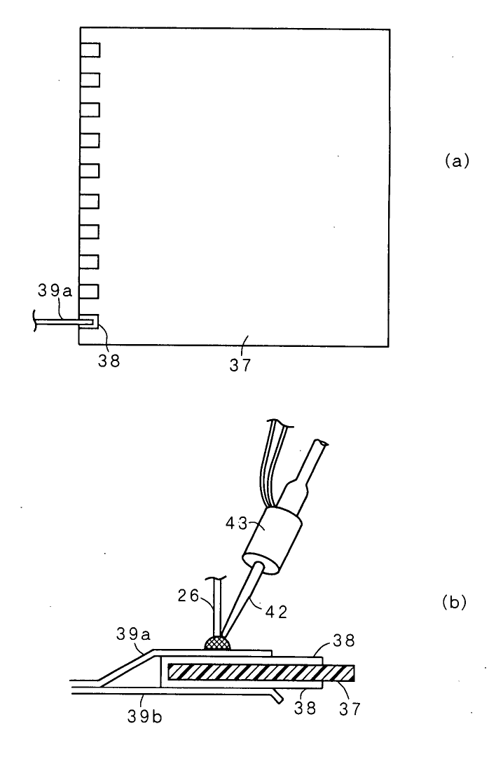

(E) As shown in FIG. 35, the plate A was fixed to a base, the plate C was drawn by a load measuring machine 36, whereby a tensile strength of the solder joint portion 35 was measured.

With regard to the solder area in a solder joint portion 35 between the plat A and plate C, an unevenness was given hereto by an adjustment of a pressing method when the plate C was placed. Results are shown in FIG. 7.

TABLE 7

| | | | Modulated electromagnetic | | |
|---|---|---|---|---|---|
| No treatment | | | wave treatment | | |
| Solder | | Tensile | Solder | | Tensile |
| area | Load | strength | area | Load | strength |
| mm² | kg | kg/mm² | mm² | kg | kg/mm² |
| 5.0 | 11.5 | 2.30 | 3.2 | 7.7 | 2.40 |
| 22.5 | 17.4 | 0.77 | 15.5 | 22.0 | 1.42 |
| 3.0 | 3.0 | 1.00 | 3.0 | 4.8 | 1.60 |
| 3.0 | 3.2 | 0.93 | 4.5 | 7.0 | 1.55 |

| | | | |
|---|---|---|---|
| Mean | 1.25 | Mean | 1.74 |

As can be understood from Table 7, an increase in the tensile strength of the solder joint portion 35 between the plate A and plate C by the modulated electromagnetic wave treatment was recognized. This is considered to be a result wherein miniaturization of solder eutectics was enhanced by the modulated electromagnetic wave treatment.

### Embodiment 4

An experiment to confirm an effect of a modulated electromagnetic wave treatment in iron soldering (robot soldering) was carried out as follows.

As shown in the plan view of FIG. 36(a) and partial side view of FIG. 36(b), a synthetic resin plate 37 has conductive terminal parts (copper patterns) 38 at its top and bottom. On the copper patterns 38, lead wire terminals 39a and 39b of Y-terminal strips and a φ1 mm thread-like solder 26 were placed, and soldering was carried out by a soldering iron 42 between the lead wire terminals 39a and 39b and copper patterns 38.

(1) Modulated Electromagnetic Wave Treatment

Since the soldering iron 42 was provided with a coil portion 43 to which an electric wire had been wound, the extent of solder spreading and wettability were observed in a case where a modulated electromagnetic wave treatment was carried out and in a case where the same was not carried out (no treatment) with application of a modulated alternating current while soldering was carried out between the lead wire terminals 39a and 39b and copper patterns 38 with heating of the soldering iron 42.

(a) Solder Material and Flux Material

A solder of Sn:Ag:Cu:In =92.5:3.0:0.5:4.0 wt % including an RMA (isopropyl alcohol and rosin of approximately 4%) flux

(b) Current Value and Frequency of Modulated Electromagnetic Wave Treatment

(A) Although a coil current value 0.1-5 A (variable) is available, since excessive spreading occurs when electromagnetic waves are too high, the value was set to an optimal value of 1 A.

(B) Modulation frequency 20 Hz-1 MHz

(c) Soldering

(A) Board: One glass epoxy resin board 37 with a size of 132 mm×70.1 mm×thickness 1.5 mm Ten conductive terminal parts (copper patterns) 38 of 4 mm×7.6 mm are disposed on the board 37, and are soldered with a φ1 mm thread-like solder 26.

(B) Lead terminals: Y-shaped terminals 39a and 39b plated with tin (Sn) and nickel (Ni)

(C) Soldering iron used: manufactured by Hakko Corporation, trade name; Bonkote, model; SR-1032

(D) Electric power: 100V AC-18W

(E) Soldering condition: temperature; 210° C., time; 4 sec

(2) Test 1 (Spread)

Soldering between the copper patterns 38 and lead wire terminals 39a and 39b was carried out by a soldering iron 42 in a case where a modulated electromagnetic wave treatment was carried out and in a case where a modulated electromagnetic treatment was not carried out (no treatment), and the extent of solder spreading was confirmed.

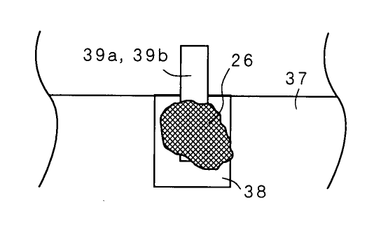

As a judging method, a ratio (%) of the solder area/copper pattern 38 area shown in FIG. 37 was determined by a visual confirmation, and a result of the mean of ten positions is shown in Table 8.

TABLE 8
(10 positions each, mean)

| | | Modulated |
|---|---|---|
| | | electromagnetic |
| Test piece (board) | No treatment | wave treatment |
| 1 | 65% | 100% |
| 2 | 70 | 98 |
| 3 | 73 | 100 |
| 4 | 70 | 100 |
| 5 | 75 | 100 |
| Mean | 71 | 100 |

According to Table 8, “wettability” was improved by a modulated electromagnetic wave treatment, thus soldering of almost the entire region of the copper patterns became possible.

### Embodiment 5

For the modulated electromagnetic wave treatment in the respective embodiments, in addition to the irradiation of electromagnetic waves from the standing coil portion, it is possible to provide an effect upon soldering by use of electromagnetic waves irradiated from a portable modulated electromagnetic wave generating device as shown in FIG. 38.

FIG. 38 is a method for carrying out soldering while orienting, in a soldering object direction, a longitudinal direction (X-axis direction) of a stick member 46, from the electromagnetic wave generator 15, around which an electric wire (coil) 45 to conduct an alternating current whose frequency temporally changes in a band of 20 Hz-1 MHz has been wound.

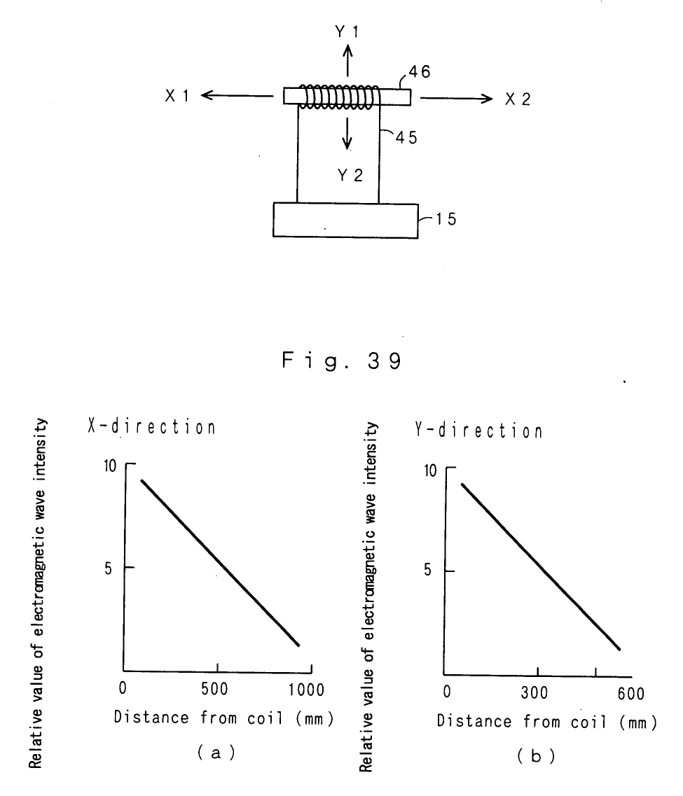

This is because, an electromagnetic wave intensity in the X-axis direction and an electromagnetic wave intensity in the Y-axis direction orthogonal to the X-axis direction in FIG. 38 are shown in FIG. 39(a) and FIG. 39(b) respectively, the intensity in the X-axis direction is stronger than the intensity in the Y-axis direction as is apparent from this FIG. 39.

Therefore, for the modulated electromagnetic wave treatment from the standing coil portion in the respective embodiments, in addition to the irradiation of electromagnetic waves from the standing coil portion, electromagnetic waves can be made effective while orienting the longitudinal direction (X-axis direction) of the stick member 46 around which the coil 45 has been wound to soldering parts of “flow soldering,” “reflow soldering,” and “iron soldering.”

In this case, similar to the electromagnetic wave intensity proportional to the coil current value, the effective range of an effect of electromagnetic waves from the stick member 46 around which the coil 45 has been wound also increases in its range.

### INDUSTRIAL APPLICABILITY

According to the present invention, by carrying out a modulated electromagnetic wave treatment of the present invention before, after, or during soldering of not only the lead-containing solder material but also the lead-free solder material on to a solder object, wettability of the solder material is remarkably improved, and intensity, etc., of the obtained soldered object is improved compared to those of a solder material without a modulated electromagnetic wave treatment. Therefore, the present invention is environmentally friendly, and can exhibit soldering performance equivalent to that of the conventional highly-evaluated lead-containing solder material, and is applicable to soldered objects of every field such as circuit boards of semiconductor devices, etc.

What is claimed is:

1. A soldering method in which, out of soldering steps of (a) during soldering, (b) before soldering, and (c) after soldering, in at least the steps of (a) during soldering and (b) before soldering, an alternating current whose frequency temporally changes in a band of 20 Hz-1 MHz is applied to at least any of (d) a solder material, (e) a soldering object, and (f) a peripheral portion thereof, and a modulated electromagnetic wave treatment is carried out by use of an electromagnetic field induced by the alternating current.

2. The soldering method according to claim 1, wherein the modulated electromagnetic wave treatment in the soldering steps of (a) during soldering, (b) before soldering, and (c) after soldering includes at least any electromagnetic wave treatment of an electromagnetic wave treatment (electromagnetic wave treatment 1) to a flux liquid itself in a flux treatment step, an electromagnetic wave treatment (electromagnetic wave treatment 2) to a flux treatment space, an electromagnetic wave treatment (electromagnetic wave treatment 3) to a preheater space in a preheater treatment which is carried out for a flux-treated soldering object, an electromagnetic wave treatment (electromagnetic wave treatment 4) carried out during soldering, an electromagnetic wave treatment (electromagnetic wave treatment 5) to a soldering space, and an electromagnetic wave treatment (electromagnetic wave treatment 6) to a cooling space in a cooling step for a soldering object after soldering.

3. The soldering method according to claim 1, wherein soldering is a soldering method of (a) a flow type whereby a molten solder material is sprayed on a soldering object, (b) a reflow type whereby a soldering object with a cream solder material applied is heated, or (c) a soldering iron type whereby soldering is carried out by holding a soldering iron to a soldering object with a solder material applied, (d) a laser type or (e) an induction heating type.

4. The soldering method according to claim 1, wherein the solder material is a lead-free solder material or a lead-containing material.

5. The soldering method according to claim 1, wherein the lead-free solder material is a solder alloy of an Sn—Ag—Cu base, an Sn—Ag base, an Sn—Ag—Bi base, an Sn—Ag—In base, an Sn—Cu base, an Sn—Zn base, an Sn—Bi base, an Sn—In base, Sn—Sb base, an Sn—Bi—In base, an Sn—Zn—Bi base, or an Sn—Ag—Cu—Sb base.

6. The soldering method according to claim 1, wherein the lead-free solder material has a solder composition which is reduced in Ag content (% by weight) of a solder alloy of a 96.5% Sn-3.0% Ag-0.5% Cu base or a solder alloy of a 96.0% Sn-3.5% Ag-0.5% Cu base to a ratio of 0.5% to above 0% and which uses the reduced amount of Ag as an increasing amount of an Sn content.

7. The soldering method according to claim 1, wherein in addition to the modulated electromagnetic wave treatment, soldering is carried out while a longitudinal direction of a stick member provided with a coil which conducts an alternating current whose frequency temporally changes in a band of 20 Hz-1 MHz is oriented in the direction of the soldering object.

8. The soldering method according to claim 1, wherein simultaneously with the modulated electromagnetic wave treatment, another electromagnetic wave treatment including an infrared and/or far-infrared treatment is used in a step before or after soldering.

9. A soldering device comprising:
a solder material applying portion for applying a solder material to a soldering object;
a soldering object and/or a solder material for soldering of the soldering object, and/or a coil-wound coil portion provided in the vicinity of the solder material, and
an electromagnetic wave generator which applies an alternating current whose frequency temporally changes in a band of 20 Hz-1 MHz to an electric wire of the coil portion.

10. A soldering device according to claim 9, wherein
in addition to the coil portion, provided is a stick member onto which a coil which conducts an alternating current whose frequency temporally changes in a band of 20 Hz-1 MHz has been wound and whose longitudinal direction has been oriented in the direction of the soldering object.

11. A soldering device according to claim 10, wherein
the solder material applying portion is composed of a molten solder storing molten solder bath attached with a preheating device and/or a flux treatment device and a molten solder supply pipe with an exhaust nozzle to spout the molten solder toward the soldering object, disposed in the molten solder bath,
the coil portion is provided in the vicinity of the molten solder bath and/or in the molten solder supply pipe.

12. A soldering device according to claim 11, wherein
the coil portion provided in the vicinity of the molten solder bath is provided, in the molten solder bath including the preheating device and/or flux treatment device, in the vicinity of the soldering object on the inside and/or outside of the molten solder bath before being soldered and/or after being soldered.

13. A soldering device according to claim 11, wherein
the molten solder supply pipe disposed in the molten solder bath is provided with a molten solder intrusion-preventing pipe connected to an outer peripheral portion thereof, and the coil portion is constructed by inserting a coil into the molten solder supply pipe via the inside of the molten solder intrusion-preventing pipe and winding the same.

14. A soldering device according to claim 13, wherein
the coil portion is constructed by winding, onto a coil installing member connected to the molten solder intrusion-preventing pipe through the inside of the molten solder intrusion-preventing pipe, a coil introduced onto this coil installing member through the inside of the molten solder intrusion-preventing pipe.

15. A soldering device according to claim 14, wherein
a longitudinal direction of the coil installing member is connected, inside the molten solder intrusion-preventing pipe, to in the direction orthogonal to a longitudinal direction of the molten solder supply pipe.

16. A soldering device according to claim 14, wherein
the coil provided onto the coil installing member has been wound around the coil installing member by single winding or double or more lap winding.

17. A soldering device according to claim 14, wherein
the coil installing member is provided double with a parallel arrangement in a longitudinal direction of the molten solder supply pipe, and onto these coil installing members, a coil is wound in a figure of zero or in a figure of eight across the two coil installing members.

18. The soldering device according to claim 9, wherein
the solder applying portion is provided with a transfer means for transferring a solder object provided by applying a cream solder to a solder object from an upstream side to a downstream side, a heating means for heating the soldering object being transferred by the transfer means, and a cooling means, and
the coil portion is provided with a coil wound around the transfer means for transferring the solder object.

19. The soldering device according to claim 18, wherein
the coil portion is constructed by arranging a coil in a direction orthogonal to a transferring direction of a soldering object transferred by the transferring means and so as to surround the soldering object.

20. The soldering device according to claim 18, wherein
the heating means is composed of a preheating portion provided on an upstream side in the transferring direction of the transferring means and a main heating portion provided on a downstream side thereof, and the cooling means is provided on a downstream side of the real heating portion.

21. The soldering device according to claim 9, wherein
the solder applying portion is provided with a soldering iron for carrying out soldering by being made to contact with or being made proximate to a soldering object with a solder applied, and
the coil portion is constructed by winding a coil around a part of the soldering iron.

22. A method for manufacturing soldered articles, wherein
the soldering method according to claim 1 is incorporated in manufacturing steps.

23. The method for manufacturing a soldered article according to claim 22, wherein
the soldered article is electronic/electrical equipment which requires soldering including a semiconductor device.

24. A soldered article obtained by the soldering method according to claim 1.

25. The soldered article according to claim 24, wherein
the soldered article is electronic/electrical equipment which requires soldering including a semiconductor device.

26. A method for manufacturing a soldered article including the soldering device according to claim 9.

27. The method for manufacturing a soldered article according to claim 26, wherein
the soldered article is (a printed circuit board for) electronic/electrical equipment including a semiconductor device.
